(19) United States
(12) Patent Application Publication
(10) Pub. No.: US 2019/0165532 A1
(43) Pub. Date: May 30, 2019

(54) ULTRASONIC BONDING METHOD OF CONDUCTOR OF ELECTRIC WIRE, METHOD OF MANUFACTURING TERMINAL-EQUIPPED ELECTRIC WIRE, ULTRASONIC BONDING APPARATUS FOR CONDUCTOR OF ELECTRIC WIRE AND ELECTRIC WIRE

(71) Applicant: Yazaki Corporation, Tokyo (JP)

(72) Inventors: Tomoya SATO, Shizuoka (JP); Naoki ITO, Shizuoka (JP); Yasunori NABETA, Shizuoka (JP); Shinya WARASHINA, Shizuoka (JP)

(73) Assignee: Yazaki Corporation, Tokyo (JP)

(21) Appl. No.: 16/199,526

(22) Filed: Nov. 26, 2018

(30) Foreign Application Priority Data
Nov. 28, 2017 (JP) 2017-227452

(51) Int. Cl. H01R 43/02; B23K 20/10; H01R 4/02

(52) U.S. Cl. CPC H01R 43/0207; B23K 2101/38; H01R 4/023; B23K 20/10

(57) ABSTRACT

An ultrasonic bonding method of a conductor of an electric wire includes ultrasonically bonding strands forming a conductor of at least one electric wire using anvils and a horn. The anvils are arranged in a longitudinal direction of the strands.

### CROSS REFERENCE TO RELATED APPLICATION

This application is based upon and claims the benefit of priority from the prior Japanese Patent Application No. 2017-227452, filed on Nov. 28, 2017, the entire contents of which are incorporated herein by reference.

### BACKGROUND

### 1. Technical Field

The disclosure relates to an ultrasonic bonding method of a conductor of an electric wire and the like, and in particular, to a method of ultrasonically bonding a plurality of strands constituting a conductor using a plurality of anvils.

### 2. Related Art

JP 2009-231079 A discloses a terminal-equipped electric wire 301 as shown in FIGS. 1A to 1C, 3 and 4.

The terminal-equipped electric wire 301 is formed as follows. First, with respect to an electric wire 307 (see FIG. 1A) in which a sheath 303 is removed at one end portion and a conductor 305 (core wire) is exposed, the exposed tip portion of the conductor 305 is bonded by ultrasonic bonding (see FIG. 1B).

That is, respective strands 311 are ultrasonically bonded at the tip portion of the conductor 305 constituted by a plurality of strands 311 to form a bonded portion 309.

A terminal-equipped electric wire 301 (see FIG. 1C) is provided by caulking a wire barrel 313 at the bonded portion 309 and installing a terminal 315.

Here, the bonding of the strands 311 by a conventional ultrasonic bonding will be described. In the conventional ultrasonic bonding, as shown in FIG. 2A, while a plurality of strands 311 are sandwiched by a single anvil 317 and a single horn 319 with a predetermined pressure, the horn 319 is made to vibrate.

### SUMMARY

When the strands 311 of the conductor 305 of the electric wire 307 are sandwiched by one anvil 317 and one horn 319 to vibrate the horn 319 to perform ultrasonic bonding, the value of the length L3 of the conductor 305 to which a force is applied by the anvil 317 may not be constant (see FIGS. 2A to 2C).

That is, if the length L2 of the exposed conductor 305 is shorter than the length L1 of the anvil 317 or the horn 319, the value of the length L3 of the conductor 305 to which the sandwiching force is applied by the anvil 317 is not constant depending on the position of the electric wire 307 with respect to the anvil 317 and the horn 319 (the position of the electric wire 307 in the longitudinal direction; the position in the lateral direction in FIGS. 2A to 2C), and the variation of the removal length L2 of the sheath 303 (the variation of the length L2 of the exposed conductor 305).

For example, despite the fact that the bonded portion 309 should be formed at the portion of the length L3 shown in FIG. 2A, as shown in FIG. 2B, when the length L2 of the exposed conductor 305 is longer than a target value, the length L3 of the conductor 305 sandwiched by the anvil 317 and the horn 319 is longer than the target value, whereby the bonded portion 309 longer than the target value is formed.

Further, as shown in FIG. 2C, if the distance between the sheath 303 and the anvil 317 or the horn 319 is more than the target value (away from each other by the dimension L4), the length L3 of the conductor 305 sandwiched by the anvil 317 and the horn 319 is shorter than the target value, whereby the bonded portion 309 shorter than the target value is formed.

The length of the conductor 305 sandwiched by the anvil 317 and the horn 319 is shifted from the target value, whereby the pressure (the force per unit length received by the conductor 305; the force per unit area that the conductor 305 receives) of the exposed conductor 305 (the strand 311) is changed. Thus, the shape of the bonded portion 309 is unstable (the shape varies), and removal of the oxide film on the strand 311 when ultrasonic bonding is performed and the form of bonding between the strands 311 are unstable.

The disclosure is directed to an ultrasonic bonding method of a conductor of an electric wire, and the like which can stabilize removal of an oxide film on strands during the ultrasonic bonding and a form of bonding of the strands when ultrasonically bonding a plurality of strands constituting a conductor to each other.

An ultrasonic bonding method of a conductor of an electric wire in accordance with some embodiments includes ultrasonically bonding strands forming a conductor of at least one electric wire using anvils and a horn. The anvils are arranged in a longitudinal direction of the strands.

The conductor may be exposed over a predetermined length due to absence of a sheath at one end portion of the electric wire in a longitudinal direction of the electric wire, and when ultrasonically bonding the conductor, a predetermined number of anvils of the anvils may be used in order from an anvil located close to the sheath depending on a length of the exposure of the conductor in the longitudinal direction.

A dimension value of a first anvil of the anvils in a longitudinal direction of the strands may be larger than a dimension value of a second anvil of the anvils in the longitudinal direction of the strands, the second anvil being adjacent to the first anvil in the longitudinal direction of the strands and positioned closer to the one end portion of the electric wire than the first anvil.

When performing the ultrasonic bonding, the strands may be sandwiched by respective planar portions of the anvils, and pressing forces per unit area of the respective planar portions of the anvils may be equal to each other.

An ultrasonic bonding method of a conductor of an electric wire in accordance with some embodiments includes ultrasonically bonding strands forming a conductor of an electric wire using an anvil and a horn. One end portion of the conductor in a longitudinal direction of the conductor protrudes from one end of a sandwiched portion formed by the anvil and the horn, or a position of one end of the conductor in the longitudinal direction and a position of the one end of the sandwiched portion match with each other in the longitudinal direction. The other end portion of the conductor in the longitudinal direction protrudes from the other end of the sandwiched portion in the longitudinal direction.

A method of manufacturing a terminal-equipped electric wire in accordance with some embodiments includes: by using the ultrasonic bonding method of a conductor of an electric wire according to at least one of the aforementioned methods, forming a bonded portion by bonding the conductor at a part of an exposed portion of the conductor in a longitudinal direction of the electric wire, the exposed portion at which the conductor is exposed due to absence of a sheath over a predetermined length at a part of the electric wire in the longitudinal direction; and after forming the bonded portion, installing a terminal with a wire barrel on an electric wire such that the wire barrel covers at least a part of the bonded portion with an end of the wire barrel on a sheath side of the electric wire being located closer to the sheath than an end of the bonded portion on the sheath side.

The at least one electric wire may include electric wires, the terminal may be a single terminal, and the single terminal may be installed on the electric wires.

An ultrasonic bonding apparatus for a conductor of an electric wire in accordance with some embodiments includes anvils and a horn. The ultrasonic bonding apparatus is configured to ultrasonically bond strands forming the conductor of the electric wire using the anvils and the horn. The anvils are arranged in a longitudinal direction of the strands.

An electric wire in accordance with some embodiments includes: strands forming a conductor; and a bonded portion formed at least in a part of the strands in a longitudinal direction of the strands. A part of a surface of the bonded portion includes a first pressed portion and a second pressed portion. The first pressed portion and the second pressed portion are arranged in a row in a longitudinal direction of the bonded portion.

According to the above configuration, when ultrasonically bonding a plurality of strands constituting a conductor, removal of the oxide film by the strand at the time of ultrasonic bonding and the form of bonding of the strands can be stabilized.

### BRIEF DESCRIPTION OF DRAWINGS

FIGS. 1A to 1C are views of a related terminal-equipped electric wire.

FIGS. 2A to 2C are views showing ultrasonic bonding of a conductor of a conventional electric wire.

FIG. 3 is a view of a related terminal-equipped electric wire.

FIG. 4 is a view of a related terminal-equipped electric wire.

FIGS. 5A to 5C are diagrams illustrating an ultrasonic bonding apparatus for a conductor of an electric wire used in an ultrasonic bonding method of conductors of electric wires according to an embodiment of the present invention.

FIG. 6 is a view illustrating the ultrasonic bonding apparatus of the conductor of the electric wire used in the ultrasonic bonding method of the conductor of the electric wire according to the embodiment of the present invention.

FIG. 7 is a view taken in the direction of arrow VII in FIG. 6.

FIG. 8 is a view illustrating an ultrasonic bonding apparatus of a conductor of an electric wire used in an ultrasonic bonding method of a conductor of an electric wire according to a modification.

FIG. 9 is a perspective view of the electric wire generated by the ultrasonic bonding method of the conductor of the electric wire according to the embodiment of the present invention.

FIG. 10A is a view taken in the direction of arrow X in FIG. 6.

FIG. 10B is a view of an anvil according to a modification corresponding to FIG. 10A.

FIG. 11 is a diagram showing an ideal mode of ultrasonic bonding of a conductor of an electric wire using an anvil and a horn.

FIG. 12 is a diagram showing an ideal mode of ultrasonic bonding of a conductor of an electric wire using an anvil and a horn.

FIG. 13 is a view of a terminal-equipped electric wire to be manufactured by installing the terminal on the electric wire having the bonded portion formed by the ultrasonic bonding method of the conductor of the electric wire according to the embodiment of the present invention and shows a state before the terminal is installed on the electric wire.

FIG. 14 is a view showing a schematic configuration of a terminal-equipped electric wire which has been manufactured by installing a terminal on an electric wire having a bonded portion formed by an ultrasonic bonding method of a conductor of an electric wire according to an embodiment of the present invention.

FIG. 15 is a cross-sectional view showing a schematic configuration of a terminal-equipped electric wire which has been manufactured by installing a terminal on an electric wire having a bonded portion formed by an ultrasonic bonding method of a conductor of an electric wire according to an embodiment of the present invention.

FIG. 16 is a diagram showing a state of a terminal-equipped electric wire according to a modification before a terminal is installed on an electric wire.

FIG. 17 is a cross-sectional view showing a schematic configuration of a terminal-equipped electric wire according to a modification.

FIG. 18 is a view schematically showing the terminal-equipped electric wires of FIG. 17.

FIG. 19 is a view schematically showing a modification of the terminal-equipped electric wire of FIG. 17.

FIG. 20 is a view of a terminal-equipped electric wire according to a modification in which a bonded portion is formed at an intermediate portion in the longitudinal direction of the electric wire and a terminal is installed thereon.

FIG. 21 is a view of a terminal-equipped electric wire according to a modification in which one terminal is installed on a plurality of (for example, two) electric wires.

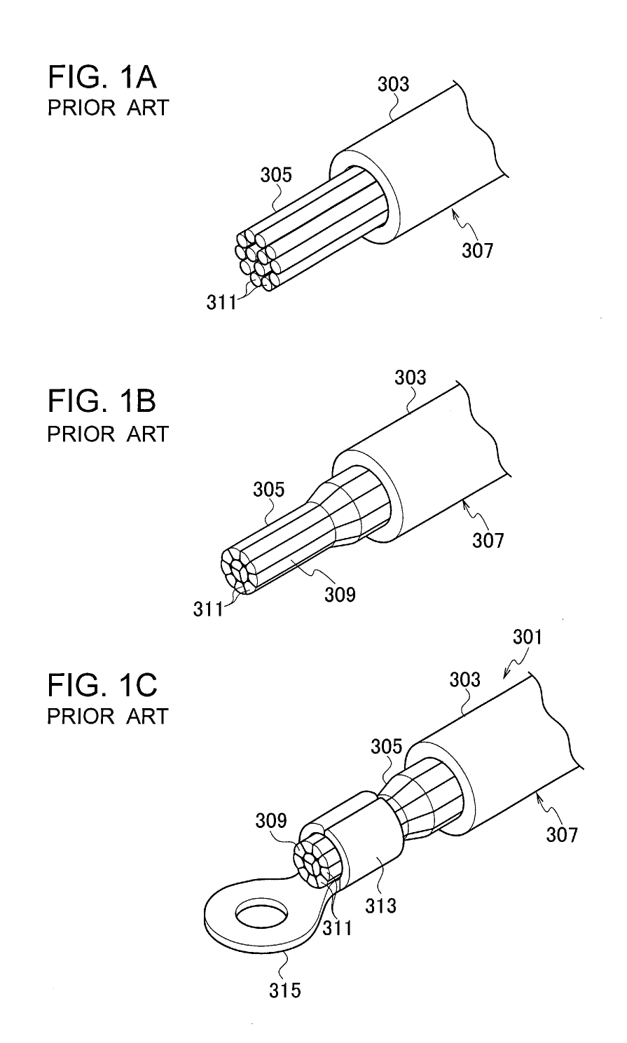

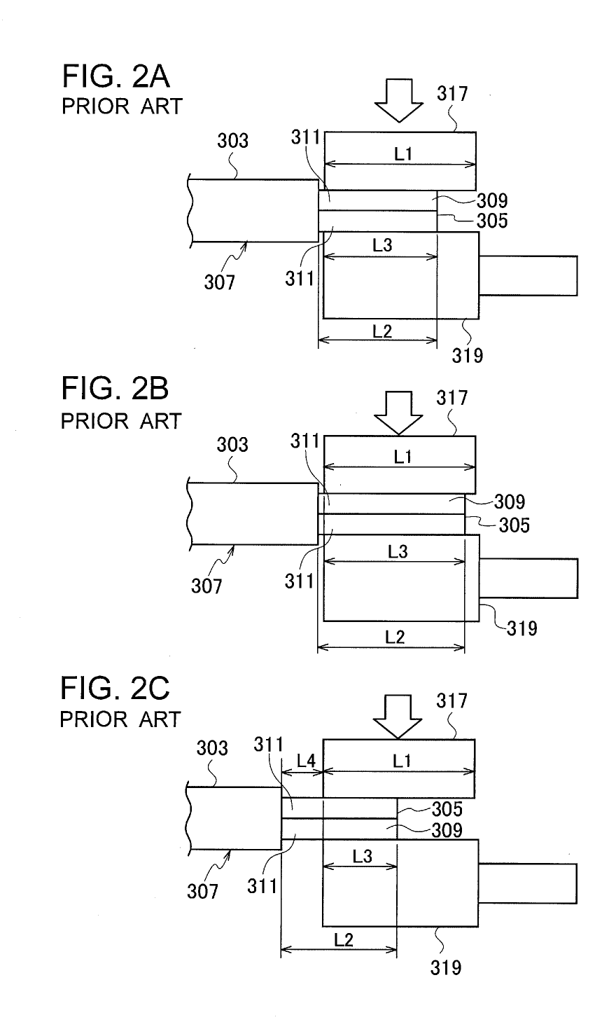

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for an embodiment of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

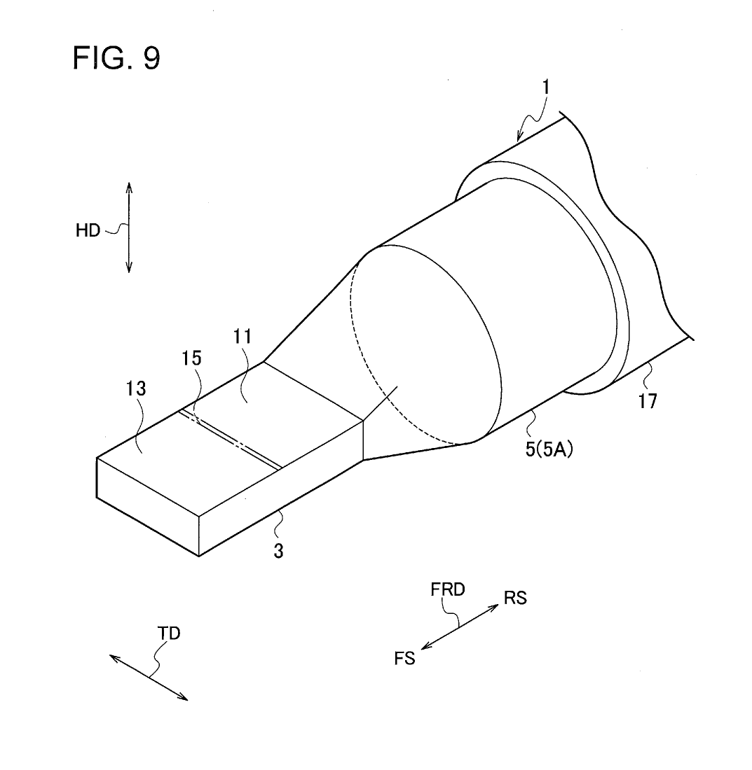

An electric wire 1 obtained through an ultrasonic bonding method of a conductor of an electric wire according to an embodiment of the present invention will be described with reference to FIG. 9 and the like.

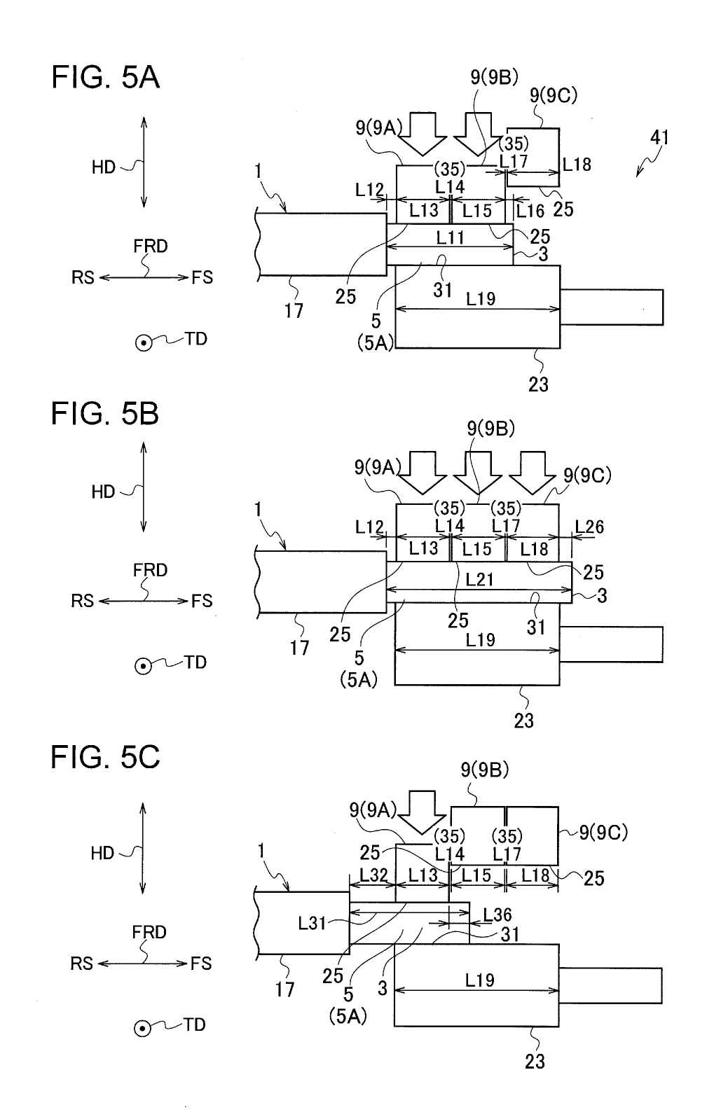

Here, for convenience of explanation, a longitudinal direction of the electric wire 1 is defined as the front-rear direction, a predetermined direction orthogonal to the front-rear direction is defined as the height direction, and a direction orthogonal to the longitudinal direction and the height direction is defined as the lateral direction. As will be described later, a predetermined direction in a terminal-equipped electric wire 101 is defined as a front-rear direction (a longitudinal direction of an electric wire 105), a predetermined direction orthogonal to the front-rear direction is defined as a height direction, and a direction orthogonal to the front-rear direction and the height direction (a height direction of the electric wire 105) is defined as a width direction (a lateral direction of the electric wire 105). In FIGS. 5A to 21, FRD, HD, TD, WD, FS and RS indicate the front-rear direction, the height direction, the lateral direction, the width direction, the front side, and the rear side, respectively.

A bonded portion 3 is formed on the electric wire 1. The bonded portion 3 is formed at at least part of the electric wire 1 in the longitudinal direction (an exposed conductor 5A). Further, the bonded portion 3 is formed such that a plurality of strands 7 (each strand is not shown in FIG. 9, see FIG. 7) constituting a conductor 5 of the electric wire 1 is ultrasonically bonded (ultrasonic wave treatment). For example, in the bonded portion 3, the conductor 5 is made into a single wire.

The bonded portion 3 of the electric wire 1 is, for example, formed into a rectangular parallelepiped shape, and a first pressed portion 11 pressed by a first anvil 9A used for ultrasonic bonding (for example, see FIG. 5A) and a second pressed portion 13 pressed by a second anvil 9B (for example, see FIG. 5A) are formed on part of the surface of the bonded portion 3.

The second anvil 9B is configured separately from the first anvil 9A, and is used for ultrasonic bonding at the same time as the first anvil 9A.

In the electric wire 1, the first pressed portion 11 and the second pressed portion 13 are arranged side by side, for example, in the front-rear direction of the electric wire 1, and are present slightly apart from each other in the front-rear direction of the electric wire 1. A non-pressed portion 15 which is not pressed by each anvil 9 (the first anvil 9A or the second anvil 9B) is formed between the first pressed portion 11 and the second pressed portion 13.

The dimension value of the width of the non-pressed portion 15 (the value of the dimension in the front-rear direction) is very small. Also, for example, the non-pressed portion 15, although not shown in FIG. 9, slightly protrudes from the planar portions of the first pressed portion 11 and the second pressed portion 13.

In addition, when comparing the height (thickness) of the first pressed portion 11 with the height (thickness) of the second pressed portion 13, the heights may be slightly different in some cases.

Further, when the non-pressed portion 15 is not present and the height (thickness) of the first pressed portion 11 is compared with the height (thickness) of the second pressed portion 13, since the heights are slightly different, a slight step may be formed between the first pressed portion 11 and the second pressed portion 13 in some cases.

Note that three or more pressed portions may be provided, and two or more non-pressed portions partitioning each pressed portion may be provided.

Furthermore, since the bonded portion 3 is formed at the intermediate portion in the longitudinal direction of the exposed conductor (the exposed conductor 5A) a plurality of unbonded strands 7 may extend on the front side relative to the front end of the bonded portion 3.

On the bonded portion 3 of the electric wire 1 shown in FIG. 9 the wire barrel of the terminal is installed (fixed), for example, in the same manner as in the case of a conventional terminal-equipped electric wire 301. Details of the terminal-equipped electric wire 101 (see FIG. 12 and the like) manufactured by installing a terminal on the electric wire 1 on which the bonded portion 3 is formed will be described later.

Next, an ultrasonic bonding method of the conductor of the electric wire 1 according to the embodiment of the present invention will be described.

As shown in FIGS. 5A to 7, in the ultrasonic bonding method of the conductor 5 of the electric wire 1, the ultrasonic bonding is performed by ultrasonically bonding a plurality of strands 7 constituting the conductor 5 (core wire) of the electric wire 1 to each other using a horn 23 and the anvil 9.

A plurality of anvils 9 (for example, three) are provided. Each of the plurality of anvils 9 (the first anvil 9A, the second anvil 9B, and a third anvil 9C) are separately configured, and they are in contact with each other or in non-contact state. Each of the anvils 9A, 9B, and 9C is arranged side by side in the longitudinal direction (front-rear direction) of each strand 7 (electric wire 1; conductor 5).

The electric wire 1 includes the conductor 5 (core wire) formed by collecting a plurality of strands 7, and a sheath 17 (insulator) covering (sheathing) the conductor 5.

In addition, in the electric wire 1 before each of the strands 7 is ultrasonically bonded to each other, the conductor 5 is exposed over a predetermined length (the exposed conductor 5A is formed) due to absence of a sheath at part (for example, one end portion) of the longitudinal direction (sheath 17 is removed).

The strand 7 of the conductor 5 is formed in an elongated columnar shape with a metal such as copper, aluminum, aluminum alloy or the like. The conductor 5 is configured in a form in which a plurality of strands 7 are twisted or in a form in which a plurality of strands 7 extend in a straight line.

Further, the electric wire 1 has flexibility. Further, a cross section (a cross section with a plane orthogonal to the longitudinal direction) of a portion where the sheath 17 of the electric wire 1 is present is formed in a predetermined shape such as a circular shape.

A cross section of the conductor 5 at the portion of the electric wire 1 where the sheath 17 is present is formed in a generally circular shape by bundling a plurality of strands 7 with almost no gaps. A cross section of the sheath 17 at the portion of the electric wire 1 where the sheath 17 is present is formed into an annular shape having a predetermined width (thickness). The entire circumference of the inner periphery of the sheath 17 is in contact with the entire circumference of the outer periphery of the conductor 5.

Ultrasonic bonding of the strands 7 is performed using, for example, a grinding jaw 19, an anvil plate 21, the horn 23, and the anvil 9, as shown in FIG. 7 and the like.

In order to facilitate understanding, first, a case where one grinding jaw 19, one anvil plate 21, one anvil 9, and one horn are used will be described.

Planes or planar portions 25, 27, 29, 31 (for example, a planar portion having fine irregularities) are formed in the anvil 9, the grinding jaw 19, the anvil plate 21, and the horn 23 respectively.

A planar portion 27 of a grinding jaw 19 and a planar portion 29 of the anvil plate 21 are orthogonal to the lateral direction and face each other in parallel. The distance between the planar portion 27 of the grinding jaw and the planar portion 29 of the anvil plate 21 is adjustable by moving and positioning at least one of the grinding jaw 19 and the anvil plate 21 in the lateral direction.

A planar portion 31 of the horn 23 and a planar portion 25 of the anvil 9 are orthogonal to the height direction and face each other in parallel. As already understood, the planar portion 27 of the grinding jaw 19 and the planar portion 29 of the anvil plate 21, and the planar portion 31 of the horn 23 and the planar portion 25 of the anvil 9 are orthogonal to each other.

The distance between the planar portion 31 of the horn 23 and the planar portion 25 of the anvil 9 is changed by moving at least one of the horn 23 and the anvil 9 in the height direction. For example, by moving the anvil 9 with a predetermined force with respect to the horn 23 using an actuator such as a pneumatic cylinder, the distance between the planar portion 31 of the horn 23 and the planar portion 25 of the anvil 9 is changed.

In addition, a square columnar space 33 is formed by the grinding jaw 19, the anvil plate 21, the horn 23, and the anvil 9, wherein both ends of the square columnar space are open in the front-rear direction. The square columnar space 33 is surrounded by the planar portion 27 of the grinding jaw 19, the planar portion 29 of the anvil plate 21, the planar portion 31 of the horn 23, and the planar portion 25 of the anvil 9.

When ultrasonic bonding is performed, the exposed conductor 5A (exposed conductor) enters the square columnar space 33 so that the longitudinal direction of the strand 7 matches with the front-rear direction of the square columnar space 33.

That is, when performing ultrasonic bonding, the exposed conductor 5A enters the square columnar space 33 so that the longitudinal direction of the strand 7, is parallel to (in the front-rear direction) the planar portion 27 of the grinding jaw 19, the planar portion 29 of the anvil plate 21, the planar portion 31 of the horn 23 and the planar portion 25 of the anvil 9.

With the strands 7 of the exposed conductor 5A entering into the square columnar space 33, the anvil 9 is moved toward the horn 23, the strands 7 are pressed by the anvil 9 and the horn 23, and the horn 23 is vibrated, so that the respective strands 7 are ultrasonically bonded. Ultrasonic bonding is performed between the strands 7 that have entered the square columnar space 33, so that the bonded portion 3 having a predetermined length is formed at part of the exposed conductor 5A in the longitudinal direction.

The vibration direction of the horn 23 at the time of ultrasonic bonding is, for example, the front-rear direction. Since the anvil 9 and the horn 23 press each strand 7, the planar portion 27 of the grinding jaw 19 and the planar portion 29 of the anvil plate 21 receive a pressing force from the strands 7.

Here, the case where a plurality of (for example, three) anvils 9 are provided for one grinding jaw 19, one anvil plate 21, and one horn 23 will be described in more detail.

In an mode in which three anvils 9 are provided, the above-described one anvil 9 is divided by one plane 35 (two dividing planes orthogonal to the front-rear direction) orthogonal to the planar portion 27 of the grinding jaw 19 and the planar portion 29 of the anvil plate 21, and orthogonal to the planar portion 31 of the horn 23 and the planar portion 25 of the anvil 9, and there are three anvils 9. The two dividing planes 35 are away from each other by a predetermined distance in the front-rear direction.

Although a slight gap is formed between the anvils 9 adjacent to each other among the three anvils 9A, 9B, and 9C, adjacent anvils 9 may be in contact with each other. In addition, each dividing plane 35 is present at a position dividing the square columnar space 33.

In a mode in which, for example, two anvils 9 are provided, one dividing plane 35 is present, and in a mode in which four or more anvils 9 are provided, three or more dividing planes 35 are present.

Furthermore, as described in detail later, the anvil 9 that sandwiches the conductor 5 when performing ultrasonic bonding is selected and used, for example, by individually moving each anvil 9 (9A, 9B, and 9C) with a predetermined force by a pneumatic cylinder, (see FIGS. 5A to 5C).

In the ultrasonic bonding method of the conductor 5 of the electric wire 1 according to the embodiment of the present invention, the conductor 5 to be ultrasonically bonded is the conductor 5A (exposed conductor) exposed over a predetermined length due to, as described above, absence of the sheath 17 at one end portion (front end portion) of the electric wire 1 in the longitudinal direction (the sheath 17 is removed).

Then, when ultrasonic bonding of the conductor 5 is performed, as shown in FIGS. 5A to 5C, depending on the length of the exposed conductor 5A (for example, the extended length from the sheath 17) a predetermined anvil among the anvils 9A, 9B, and 9C is used in order from, for example, an anvil (the anvil located on the rear side) located on the sheath 17 side (rear side).

To explain further, the anvil 9 to be used for ultrasonic bonding of the conductor 5 is selected so that the front end portion of the exposed conductor 5A protrudes on the front side relative to the anvil 9 by a predetermined length (there is an extra length portion of the exposed conductor 5A), or the front end of the exposed conductor 5A matches with the front end of the anvil 9.

Further, the anvil 9 to be used for ultrasonic bonding of the conductor 5 is selected so that when the front end portion of the exposed conductor 5A is protruded on the front side relative to the anvil 9 by a predetermined length, minimizing this protruding length (length of the extra length portion) is a goal.

More detail will be described by examples.

In the mode shown in FIG. 5A, the exposed conductor 5A extends forward from the front end of the sheath 17 by a length L11. The three anvils 9A, 9B, and 9C are arranged in this order from the rear side to the front side. The anvil 9A and the sheath 17 are away to each other by a distance L12 in the front-rear direction. The dimension of the anvil 9A in the front-rear direction is L13, the dimension of the anvil 9B is L15, and the dimension of the anvil 9C is L18.

The dimension L13 of the anvil 9A, the dimension L15 of the anvil 9B, and the dimension L18 of the anvil 9C are, for example, equal to each other. In this case, the value of the force (driving force) for moving the anvil 9A in the height direction for ultrasonic bonding, the value of the force (driving force) for moving the anvil 9B in the height direction for ultrasonic bonding, and the value of the force (driving force) for moving the anvil 9C in the height direction for ultrasonic bonding are equal to each other.

Note that the configuration may be made such that it is possible to individually (independently) set the force sandwiching the conductor 5 (strands 7) for each anvil (9A, 9B, and 9C). When sandwiching the strands 7, at least one of the pressing force of the anvil 9A, the pressing force of the anvil 9B, and the pressing force of the anvil 9C is made different from the pressing force of the other anvils.

Also, in the front-rear direction, the sheath 17 and the anvil 9A are away from each other by a distance L12, the anvil 9A and the anvil 9B are away from each other by a slight distance L14, and the anvil 9B and the anvil 9C are away from each other by a slight distance L17.

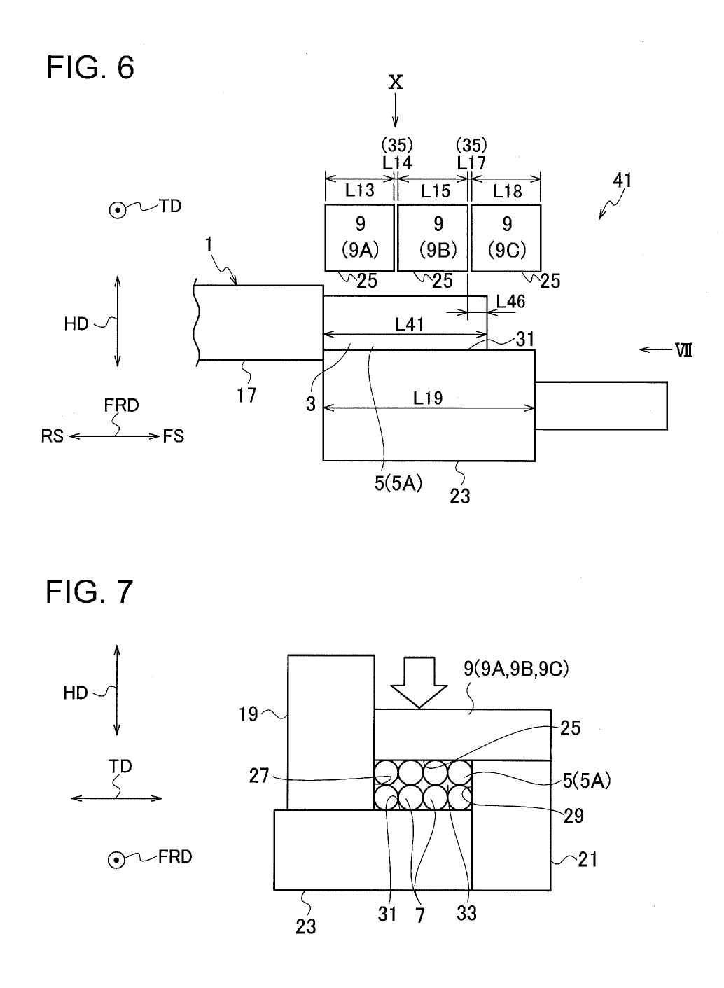

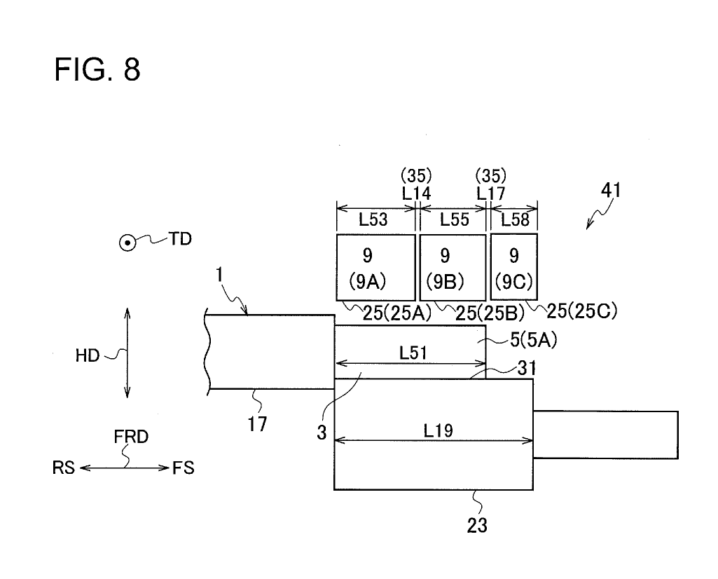

In the mode shown in FIG. 5A, the value of the distance L14 and the value of the distance L17 may be different, or at least one of the distance L12, the distance L14, and the distance L17 may be “0”. For example, as shown in FIG. 6 and FIG. 8, the value of the distance L12 may be “0”.

The dimension of the horn 23 in the front-rear direction is L19. In the front-rear direction, the positions of the rear end of the anvil 9A and the rear end of the horn 23 match with each other, and the positions of the front end of the anvil 9C and the front end of the horn 23 match with each other, and the value of the dimension L19=the value of the dimension L13+the value of the dimension L14 (distance)+the value of the dimension L15+the value of the dimension L17 (distance)+the value of the dimension L18.

In the mode shown in FIG. 5A, the anvil 9A located on the rear side and the anvil 9B adjacent to the anvil 9A are used when ultrasonically bonding the exposed conductor 5A, and the length of the extra length portion of the exposed conductor 5A (the distance between the anvil 9B and the tip (front end) of the exposed conductor 5A in the front-rear direction) is L16. Anvils 9A and 9B are used so that the value of the length L16 of the extra length portion is minimized.

Further, the number of anvils 9 (total value of dimensions of the anvils 9 in the front-rear direction) used when ultrasonically bonding the exposed conductor 5A is equal to the value of the length of the exposed conductor 5A or is smaller than the value of the length of the exposed conductor 5A. Further, 0≤(the value of the length L11 of the exposed conductor 5A−the value of the distance L12 between the anvil 9A and the sheath 17)−(the total value of the front-rear direction dimensions of the anvils 9 used in the ultrasonic bonding)≤(the dimension value of the anvil 9 in the front-rear direction located next to and on the front side of the anvil 9 used for ultrasonic bonding). For example, in FIG. 5A, L16<L17+L18.

The total value of the front-rear direction dimensions of the anvil 9 used in the ultrasonic bonding includes the value of the gap between the anvils 9, as already understood, and for example, when using the two anvils 9A and 9B, the total value of the front-rear direction dimensions of the anvils 9 used in the ultrasonic bonding is L13+L14+L15.

More specifically, assuming that ultrasonic bonding is performed using only the anvil 9A in the mode shown in FIG. 5A, the length of the extra length portion is L14+L15+L16 and is the minimum value. In addition, in the mode shown in FIG. 5A, assuming that ultrasonic bonding is performed using the anvils 9A, 9B, and 9C, no extra length portion occurs (the length of the extra length portion becomes a minus value).

In the mode shown in FIG. 5B, the exposed conductor 5A extends forward from the front end of the sheath 17 to a length L21 (L21>L11). In addition, the length of the extra length portion is L26. Other dimensions and distances are the same as those shown in FIG. 5A.

In the mode shown in FIG. 5B, when ultrasonically bonding the exposed conductor 5A, the anvil 9A located on the rear side, the anvil 9B adjacent to the anvil 9A, and the anvil 9C adjacent to the anvil 9B are used and the length of the extra length portion of the exposed conductor 5A (the distance between the anvil 9C and the tip of the exposed conductor 5A in the front-rear direction) is L26 as described above.

Also in this case, the anvils 9A, 9B, and 9C are used so that the value of the length L26 of the extra length portion is minimized.

More specifically, assuming that ultrasonic bonding is performed using only the anvils 9A and 9B in the mode shown in FIG. 5B, the length of the extra length portion is L17+L18+L26, which does not become the minimum value.

In the mode shown in FIG. 5C, the exposed conductor 5A extends forward from the front end of the sheath 17 by the length L31. In addition, the length of the extra length portion is L36. In addition, the anvil 9A and the sheath 17 are away from each other by L32 (L32>L12) in the front-rear direction. Other dimensions and distances are the same as those shown in FIG. 5A.

In the mode shown in FIG. 5C, only the anvil 9A located on the rear side is used when ultrasonically bonding the exposed conductor 5A, and the length of the extra length portion of the exposed conductor 5A (the distance between the anvil 9A and the tip of the exposed conductor 5A in the front-rear direction) is L36 as described above.

Also in this case, only the anvil 9A is used so that the value of the length L36 of the extra length portion is minimized.

To explain further, in the mode shown in FIG. 5C, if it is assumed that ultrasonic bonding is performed using the anvils 9A and 9B, no extra length portion will be generated.

In the mode shown in FIGS. 5A to 5C, the value of the length L16 of the extra length portion the value of the length L26 of the extra length portion, the value of the length L36 of the extra length portion may be “0”.

Further, in the mode shown in FIG. 6, the exposed conductor 5A extends forward from the front end of the sheath 17 to the length L41. Also, the length of the extra length portion is L46. The value of the distance L12 shown in FIG. 5A is “0”. Other dimensions and distances are the same as those shown in FIG. 5A. In the mode shown in FIG. 6, an anvil 9A located on the rear side and an anvil 9B adjacent to the anvil 9A are used when ultrasonically bonding the exposed conductor 5A.

In the mode shown in FIGS. 5A to 5C and FIG. 6, the value of the dimension L13 of the anvil 9A, the value of the dimension L15 of the anvil 9B, and the value of the dimension L18 of the anvil 9C are equal to each other in the front-rear direction. The value of the dimension L13 of the anvil 9A, the value of the dimension L15 of the anvil 9B and the value of the dimension L18 of the anvil 9C may be different.

For example, as shown in FIG. 8, the dimension value of the anvil 9A (9B) located on the other end side of the electric wire 1 (rear side: the sheath 17 side of the electric wire 1) may be greater than the dimension value of the anvil 9B (9C) located on one end side of the electric wire 1 (front side: opposite side to the sheath 17 of the electric wire 1).

Further, in the mode shown in FIG. 8, in the front-rear direction, the value of the dimension L53 of the anvil 9A>the value of the dimension L55 of the anvil 9B>the value of the dimension L58 of the anvil 9C. Further, the exposed conductor 5A extends forward by the length L51 from the front end of the sheath 17. Further, the length of the extra length portion is, for example, “0”. The value of the distance L12 is also “0” similarly to the mode shown in FIG. 6.

In the mode shown in FIG. 8, other dimensions and distances are the same as those shown in FIG. 5A. In the mode shown in FIG. 8, when the exposed conductor 5A is ultrasonically bonded, the anvil 9A located on the rear side and the anvil 9B adjacent to the anvil 9A are used.

Further, in the mode shown in FIG. 8, for the two anvils which are not adjacent to each other and between which another anvil is present, the value of “the front-rear direction dimension of the anvil on the rear side the value of the front-rear direction dimension of the anvil on the front side”.

Explaining in an easy-to-understand manner, the value of the dimension L53 of the anvil 9A=the value of the dimension L55 of the anvil 9B>the value of the dimension L58 of the anvil 9C or the value of the dimension L53 of the anvil 9A>the value of the dimension L55 of the anvil 9B=the value of the dimension L58 of the anvil 9C.

As described above, each of the anvils 9A, 9B, and 9C is configured to independently move in the height direction by an actuator (three actuators) such as a pneumatic cylinder. In the ultrasonic bonding method of the conductor 5 of the electric wire 1 shown in FIG. 8, the values of the forces (driving forces) for moving the respective anvils 9A, 9B, and 9C for ultrasonic bonding are different.

That is, when ultrasonic bonding of a plurality of strands 7 constituting the conductor 5 of the electric wire 1 is performed, the value of the force with which each anvil 9 cooperates with the horn 23 to sandwich each strand 7 is proportional to the value of the area of the planar portion 25 of the anvil 9 for sandwiching each strand 7.

For example, as shown in FIG. 8, when ultrasonic bonding is performed using the anvil 9A and the anvil 9B, the value of the force with which the anvil 9A sandwiches each strand 7/the area of a planar portion 25A (the value of the dimension L53)=the value of the force with which the anvil 9B sandwiches each strand 7/the area of a planar portion 25B (the value of the dimension L55). In other words, when ultrasonic bonding is performed, the pressing force per unit area of the planar portion 25A of the anvil 9A=the pressing force per unit area of the planar portion 25B of the anvil 9B.

When ultrasonic bonding is performed using the three anvils 9A, 9B, and 9C, as already understood, the value of the force with which the anvil 9A sandwiches each strand 7/the area of the planar portion 25A=the value of the force with which the anvil 9B sandwiches each strand 7/the area of the planar portion 25B=the value of the force that the anvil 9C sandwiches each strand 7/the area of the planar portion 25C.

In the above description, the case where three anvils are used is described as an example. The number of anvils may be two or may be four or more.

In the ultrasonic bonding method of the conductor 5 of the electric wire 1 according to the embodiment of the present invention, a plurality of anvils 9 are provided, and these anvils 9 are arranged in the longitudinal direction (front-rear direction) of each strand 7. Then, by selecting the anvil 9 to be used for ultrasonic bonding according to the length L11 (L21, L31, L41, L51) of the exposed conductor 5A, the length of the exposed conductor 5A can be made longer than the length of the anvil used for the ultrasonic bonding.

As a result, even if the positions with respect to the anvil 9 or the horn 23 of the electric wire 1 and the removal lengths of the sheath 17 vary slightly, when the strands 7 of the conductor 5 of the electric wire 1 are sandwiched by the anvils 9 and one horn 23, and the horn 23 is vibrated to perform the ultrasonic bonding, the value of the length of the conductor 5 to which a force is applied by the anvils 9 (for example, the value of L13+L15 shown in FIG. 5A) can be made constant.

Thus, when ultrasonic bonding is performed, the pressure received by the exposed conductor 5A becomes substantially constant without significant change, the shape of the bonded portion 3 is stabilized, the removal of the oxide film on the strands 7 at the time of ultrasonic bonding is properly performed, and the form of bonding between the strands 7 is stabilized.

Further, according to the ultrasonic bonding method of the conductor 5 of the electric wire 1 according to the embodiment of the present invention, when performing ultrasonic bonding of the exposed conductor 5A, a predetermined anvil among each anvil 9 is used in order from an anvil located close to the sheath 17 (the rear side) according to the length of the exposed conductor 5A, so that it is possible to form the bonded portion 3 at a position close to the sheath 17, and the length of the conductor 5 (the length of the strand that is present without bonded between the terminal and the sheath 17) when the terminal (not shown) is installed at the bonded portion 3 can be made as short as possible.

Further, according to the ultrasonic bonding method of the conductor 5 of the electric wire 1 according to the embodiment of the present invention, the dimension value of the anvil located on the rear side of the electric wire 1, is larger than the dimension value of the anvil located on the front side of the electric wire 1.

That is, the value of the length dimension of each anvil 9 arranged in the longitudinal direction of the electric wire 1 is large on the sheath 17 side and small at a position away from the sheath 17. As a result, the number of the anvils 9 can be reduced, and the length of the bonded portion 3 can be accurately secured.

Further, according to the ultrasonic bonding method of the conductor 5 of the electric wire 1 according to the embodiment of the present invention, since the value of the force sandwiching each strand 7 of each anvil 9A, 9B, and 9C is proportional to the value of the area of the planar portion 25 (the planar portion to sandwich the strands 7) of the anvil 9, regardless of the number of anvils 9 used for the ultrasonic bonding, the pressure received by the exposed conductor 5A is constant and the shape of the bonded portion 3 is further stabilized.

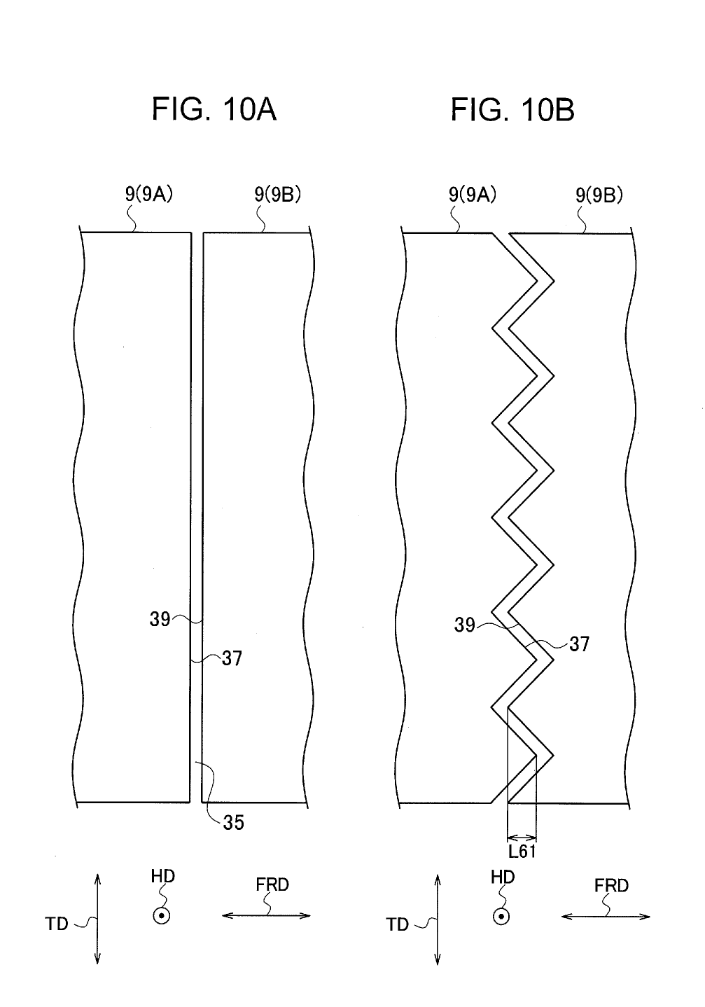

In the mode shown in FIGS. 5A to 8, as shown in FIG. 10A, in the two anvils 9 (for example, the anvils 9A and 9B) which are adjacent to each other, a face 37 of the anvil 9A facing the anvil 9B is a plane orthogonal to the front-rear direction, and a face 39 of the anvil 9B facing the anvil 9A is a plane orthogonal to the front-rear direction.

Here, as shown in FIG. 10B, appropriate irregularities may be formed on the face 37 of the anvil 9A facing the anvil 9B and the face 39 of the anvil 9B facing the anvil 9A.

That is, minute irregularities may be formed on the faces 37 and 39 of the two anvils 9 which are arranged in the longitudinal direction (front-rear direction) of each strand 7 (electric wire 1; conductor 5) and adjacent to each other wherein the faces face each other.

By the irregularities, part of one anvil 9 (for example, the anvil 9A) of the two anvils 9 in the longitudinal direction (front-rear direction) of each strand 7 and part of the other anvil 9 of the two anvils 9 (for example, anvil 9B) overlap each other.

More specifically, when viewed in the height direction, the face 37 of the anvil 9A is, for example, formed into a triangular wave shape in which the amplitude direction is the front-rear direction (other wave shape such as a rectangular wave shape or another shape in which irregularities are repeated may be formed), and the face 39 of the anvil 9B is also formed in a triangular wave shape similar to the face 37 of the anvil 9A.

In the front-rear direction, part of the face 37 of the anvil 9A and part of the face 39 of the anvil 9B overlap each other at a dimension L61.

The irregular face 37 of the anvil 9A and the irregular face 39 of the anvil 9B are slightly away from each other in the front-rear direction. The entire surface of the irregular face 37 of the anvil 9A and the irregular face 39 of the anvil 9B may be in contact with each other.

Further, the period and amplitude of a wave such as a triangular wave or the like is, for example, approximately similar to the outer diameter of one strand 7 or is smaller than the outer diameter of one strand 7 (for example, ½ to 1/10 of the diameter).

As shown in FIG. 10B, minute irregularities are formed on the faces 37 and 39 of the two anvils 9 which are mutually adjacent to each other, and by these irregularities, a part of one anvil 9A and a part of the other anvil 9B are made to overlap with each other, so that the shape of the bonded portion 3 is also stabilized at the boundary between the two anvils 9A and 9B.

Next, an ultrasonic bonding apparatus 41 for the conductor 5 of the electric wire 1 will be described.

The above-described ultrasonic bonding method of the conductor 5 of the electric wire 1 is performed, for example, by using the ultrasonic bonding apparatus 41 (see FIGS. 5A to 5C, FIG. 6 and the like) for the conductor 5 of the electric wire 1.

The ultrasonic bonding apparatus 41 (conductor bonding apparatus) for the conductor 5 of the electric wire 1 ultrasonically bonds a plurality of strands 7 constituting the conductor 5 of the electric wire 1 by using the anvil 9 and the horn 23.

The ultrasonic bonding apparatus 41 for the conductor 5 of the electric wire 1 is provided with a plurality of anvils 9. The plurality of anvils 9A and 9B is configured as a separate body, and is in contact with or in non-contact with each other. These anvils 9A and 9B are arranged in the longitudinal direction (front-rear direction) of the exposed conductor 5A.

As described above, when performing ultrasonic bonding of the conductor 5 of the electric wire 1, depending on the length of the exposed conductor 5A, a predetermined anvil among anvils 9A, 9B, and 9C is used in order from an anvil located close to the sheath 17.

The setting of the anvil 9 used for ultrasonic bonding may be performed automatically or manually.

When setting the anvil 9 used for ultrasonic bonding automatically, the ultrasonic bonding apparatus 41 of the conductor 5 of the electric wire 1 includes, for example, a position detection unit for detecting a position of the tip (front end) of the exposed conductor 5A with respect to the ultrasonic bonding apparatus 41 of the conductor 5 of the electric wire 1, a CPU, and a control unit including a memory.

Then, under the control of the control unit, the anvil 9 used for ultrasonic bonding is configured to be selected (set) in accordance with the detection result of the position detection unit.

Instead of or in addition to detecting the position of the tip (front end) of the exposed conductor 5A in the position detection unit, the length of the exposed conductor 5A, and the position of the exposed conductor 5A with respect to the ultrasonic bonding apparatus 41 for the conductor 5 of the electric wire 1 may be detected.

Further, for example, when there is a problem in that the value of the distance L12 between the anvil 9A and the sheath 17 being an inappropriate value and the like an alarm may be issued to notify the operator.

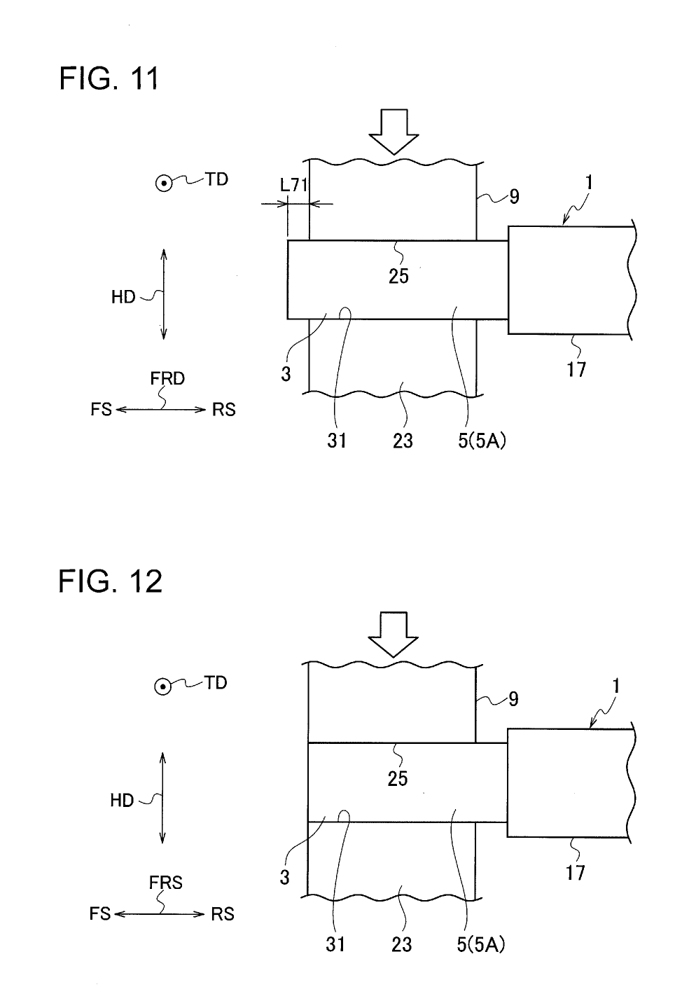

As shown in FIG. 11 and FIG. 12, by sandwiching between one anvil 9 and one horn 23, the plurality of strands 7 constituting the conductor 5 of the electric wire 1 (the strands 7 of the exposed conductor 5A where the sheath 17 is removed) may be ultrasonically bonded.

In the mode shown in FIG. 11, one end portion (front end portion) of the exposed conductor 5A in the longitudinal direction protrudes forward by a predetermined length L71 from one end (front end) of the sandwiched portion formed by the anvil 9 and the horn 23.

Further, in the mode shown in FIG. 11, the other end portion (rear end portion) of the exposed conductor 5A in the longitudinal direction protrudes from the other end (rear end) of the sandwiched portion.

Here, the sandwiched portion formed by the anvil 9 and the horn 23 is a portion where the anvil 9 and the horn overlap in the longitudinal direction (front-rear direction) of the conductor 5. In FIGS. 11 and 12, since the size and position of the anvil 9 of the conductor 5 in the longitudinal direction and the size and position of the horn 23 match with each other, the sandwiched portion is formed between the anvil 9 and the horn 23.

In the mode shown in FIG. 12, in the longitudinal direction (front-rear direction) of the conductor 5 the position of one end (front end) of the conductor 5 in the longitudinal direction matches with the position of one end (front end) of the sandwiched portion, and the other end portion (rear end portion) of the exposed conductor 5A in the longitudinal direction protrudes from the other end (rear end) of the sandwiched portion.

The mode shown in FIG. 11 and FIG. 12 is employed in order to make the length of the conductor sandwiched by the anvil and the horn constant even if the length of the conductor (exposed conductor) to be ultrasonically bonded and the position of the conductor to be ultrasonically bonded (exposed conductor) with respect to the anvil and horn in the longitudinal direction (front-rear direction) are changed.

As is already understood, the exposed conductor 5A is sandwiched by the anvil 9 and the horn 23 over a predetermined length at the sandwiched portion, and the bonded portion 3 is formed at the sandwiched portion.

More specifically, as shown in FIG. 11, for example, the sheath 17 is removed at one end portion (front end portion) of the electric wire 1 in the longitudinal direction, and an exposed conductor 5A having a predetermined length is present.

In the longitudinal direction (front-rear direction) of the conductor 5, the dimension of the anvil 9 and the dimension of the horn 23 are equal to each other as described above, and the position of the anvil 9 and the position of the horn 23 match with each other. Therefore, the sandwiching is performed in a position where the anvil 9 or the horn 23 is present in the longitudinal direction (front-rear direction) of the conductor 5.

The value of the length dimension of the exposed conductor 5A is larger than the values of the length dimensions of the anvil 9 and the horn 23. When the ultrasonic bonding is performed, the exposed conductor 5A extends from both ends of the anvil 9 and the horn 23 by a slight length in the front-rear direction. As a result, an extra length portion having a length dimension of L71 is formed at the front end portion of the exposed conductor 5A. In FIG. 12, the length of the extra length portion is “0”.

By ultrasonically bonding the exposed conductor 5A in the mode shown in FIGS. 5A to 5C or FIGS. 11 and 12, the ultrasonic bonding can be always performed in a constant area, even if the position of the electric wire 1 with respect to the horn 23 or the like (the position in the front-rear direction) is slightly shifted, and the shape of the bonded portion 3 is stabilized. By stabilizing the shape of the bonded portion 3, the value of the electric resistance between the strands 7 at the bonded portion 3 is reduced.

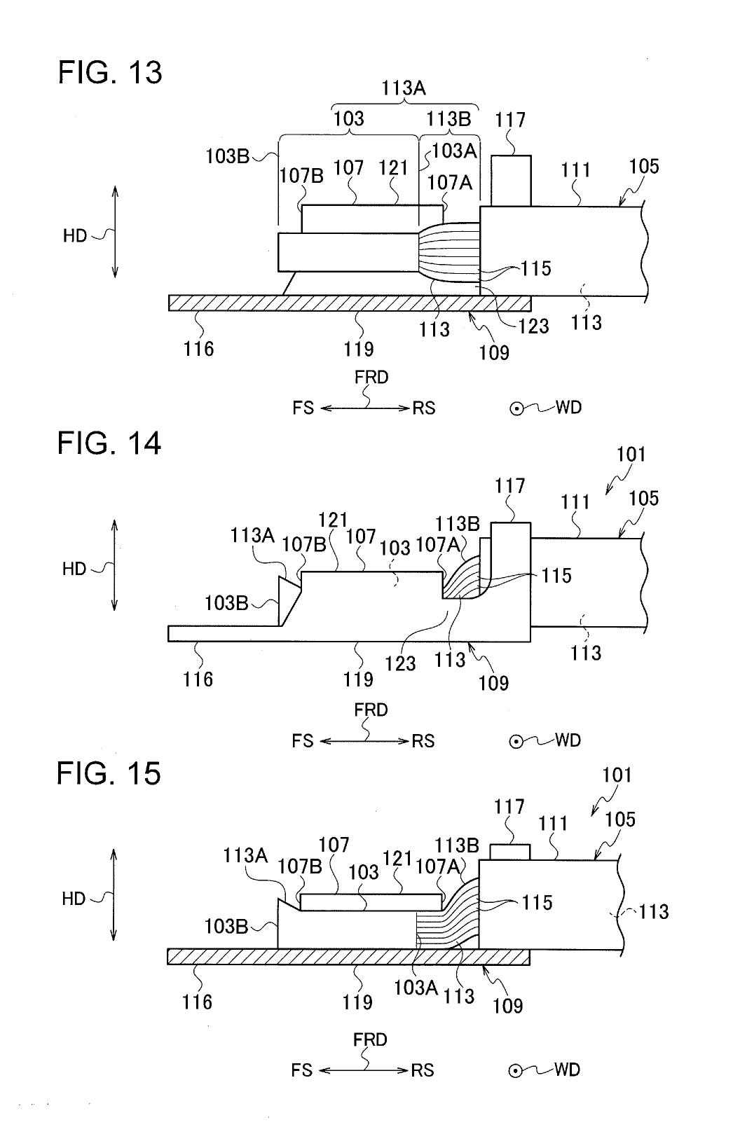

Next, with reference to FIGS. 13 to 19, the terminal-equipped electric wire 101 will be described in detail.

As shown in FIGS. 13 to 15, the terminal-equipped electric wire 101 includes an electric wire 105 (electric wire 1) where a bonded portion 103 (bonded portion 3) is formed, and a terminal 109 (terminal fitting) having a wire barrel 107.

Here, for convenience of explanation, a predetermined direction in the terminal-equipped electric wire 101 is defined the front-rear direction (a longitudinal direction of the electric wire 105), a predetermined direction orthogonal to the front-rear direction is defined the height direction, and a direction orthogonal to the front-rear direction and the height direction (the height direction of the electric wire 105) is defined as the width direction (the lateral direction of the electric wire 105).

As described above, a conductor 113 (conductor 5) is exposed due to absence of a sheath 111 (sheath 17) over a predetermined length at part (for example, one end portion) of the electric wire 105 in the longitudinal direction (length direction) (for example, part of the sheath 111 is removed).

The bonded portion 103 to which the conductor 113 is bonded is formed over a predetermined length at part of the exposed conductor 113A (exposed conductor) of the electric wire 105. The bonded portion 103 is formed by, for example, ultrasonically bonding a plurality of strands 115 (strands 7) constituting the conductor 113.

More specifically, the electric wire 105 includes the conductor 113 (core wire) formed by collecting a plurality of strands 115 and a sheath 111 (insulator) covering (sheathing) the conductor 113.

The strands 115 of the conductor 113 are formed in an elongated columnar shape with a metal such as copper, aluminum, aluminum alloy or the like. The conductor 113 is configured in a form in which a plurality of strands 115 are twisted or in a form in which a plurality of strands 115 linearly extend in a lump.

Further, the electric wire 105 has flexibility. A cross section (a cross section which is a plane orthogonal to the longitudinal direction) of a portion of the electric wire 105 where the sheath 111 is present is formed in a predetermined shape such as a circular shape.

The cross section of the conductor 113 at the portion of the electric wire 105 where the sheath 111 is present is, for example, formed in a substantially circular shape because the plurality of strands 115 are bundled with almost no gaps. The cross section of the sheath 111 at the portion of the electric wire 105 where the sheath 111 is present is, for example, formed in an annular shape having a predetermined width (thickness). The entire circumference of the inner periphery of the sheath 111 is in contact with the entire circumference of the outer periphery of the conductor 113.

In the bonded portion 103, the plurality of strands 115 constituting the conductor 113 are ultrasonically bonded to each other as described above, whereby the conductor 113 is bonded.

In the above description, the bonded portion 103 is formed by the ultrasonic bonding. The bonded portion 103 may be formed by bonding the strands 115 by a bonding method other than ultrasonic bonding. For example, the strands 115 may be metallurgically bonded to each other at a temperature equal to or lower than the recrystallization temperature of the strand 115, whereby the bonded portion 103 may be formed in the same manner as in the case of the ultrasonic bonding.

Further, the bonded portion 103 may be formed by a process other than ultrasonic wave treatment, such as cold welding, friction stir welding, friction pressure welding, electromagnetic pressure welding, diffusion bonding, brazing, soldering, resistance welding, electron beam welding, laser welding, light beam welding or the like.

The bonded portion 103 and the sheath 111 are away from each other by a predetermined length in the longitudinal direction of the electric wire 105, for example. As a result, a plurality of strands 113B (conductors in a non-bonded state) which is in contact with each other, but is in a non-bonded state is exposed between the bonded portion 103 and the sheath 111.

That is, the bonded portion 103 having a predetermined length, a conductor 113B in a non-bonded state, and the conductor 113 covered with the sheath 111 (a portion of the electric wire 105 where the sheath 111 is present) are arranged in this order from the one end toward the other end of the electric wire 105 in the longitudinal direction.

The cross-sectional shape (sectional shape represented by a plane orthogonal to the longitudinal direction) of the bonded portion 103 before the terminal 109 is installed is formed in a predetermined shape such as a rectangular shape.

In addition, the cross-sectional shape (cross-sectional shape represented by a plane orthogonal to the longitudinal direction) of the conductor 113B in a non-bonded state before the terminal 109 is installed, gradually shifts from the sectional shape of the bonded portion 103 to the cross-sectional shape of the conductor 113 covered with the sheath 111.

In the terminal-equipped electric wire 101, the longitudinal direction of the electric wire 105 and the conductor 113, and the front-rear direction of the wire barrel 107 (the terminal 109) match with each other. One end of the electric wire 105 in the longitudinal direction is located on the front side, and the other end of the electric wire 105 in the longitudinal direction is located on the rear side.

Further, in the terminal-equipped electric wire 101, an end 107A (rear end: the end located on the sheath 111 side in the front-rear direction) of the wire barrel 107 of the terminal 109 is located on the sheath 111 side (rear side) relative to the end 103A (rear end; end located on the sheath 111 side in the longitudinal direction) of the bonded portion 103. In the terminal-equipped electric wire 101, for example, by caulking the wire barrel 107, the wire barrel 107 wraps and covers at least part of the bonded portion 103.

The terminal 109 is formed, for example, by forming a flat metal material in a predetermined shape and then folding the terminal formed in the predetermined shape.

For example, a terminal connection portion 116 connected to the mating terminal, the wire barrel 107 and an insulation barrel portion 117 are arranged in this order from the front side to the rear side of the terminal 109. For example, the sectional shape of the wire barrel 107 (the cross-sectional shape represented by a plane orthogonal to the front-rear direction) before being caulked is, for example, formed in a U-shape with a bottom plate portion 119 (arc-shaped bottom plate portion) in which the thickness direction is substantially the height direction, and a pair of side plate portions 121. Each of the pair of side plate portions 121 stands obliquely upward from both ends of the bottom plate portion 119 in the width direction. The dimension value (dimension value in the width direction) between the pair of side plate portions 121 gradually increases from the lower side to the upper side.

The sectional shape of the insulation barrel portion 117 before being caulked (the sectional shape represented by a plane orthogonal to the front-rear direction) is also formed in a U-shape similar to the cross section of the wire barrel 107.

In the terminal-equipped electric wire 101, as the wire barrel 107 is caulked, the bonded portion 103 and the wire barrel 107 are integrated with each other, and as the insulation barrel portion 117 is caulked, the sheath 111 and the insulation barrel portion 117 are integrated with each other.

The caulking of the wire barrel 107 and the insulation barrel portion 117 is mainly performed by plastically deforming the pair of side plate portions 121 and making the wire barrel 107 and the insulation barrel portion 117 into a cylindrical shape. By caulking the wire barrel 107, the bonded portion 103 is deformed. By the caulking, almost the entire inner surface of the cylinder of the wire barrel 107 is in contact with the bonded portion 103 with an urging force.

Further, in the front-rear direction, for example, the wire barrel 107 and the insulation barrel portion 117 are slightly away from each other (a connection portion 123 is provided therebetween). The wire barrel 107 may be in contact with the insulation barrel portion 117.

Here, the relationship between the electric wire 105 and the terminal 109 in the front-rear direction will be described in more detail.

In the longitudinal direction of the electric wire 105, as described above, from the front side to the rear side, the bonded portion 103 having a predetermined length, the conductor 113B in a non-bonded state, and the conductor 113 covered with the sheath 111 are arranged in this order. The length of the conductor 113 covered with the sheath 111 is much longer than the length of the bonded portion 103 or the conductor 113B in the non-bonded state.

In the front-rear direction of the terminal 109, as described above, from the front side to the rear side, the terminal connection portion 116, the wire barrel 107, the connection portion 123 between the wire barrel 107 and the insulation barrel portion 117, and the insulation barrel portion 117 are arranged in this order. The dimension value of the wire barrel 107 in the front-rear direction is larger than the dimension value of the connection portion 123 and the insulation barrel portion 117 in the front-rear direction.

In the terminal-equipped electric wire 101, as shown in FIG. 15 etc., in the front-rear direction, one end 103B (front end) of the bonded portion 103 is located slightly on the front side relative to the front end 107B of the wire barrel 107. Thus, one end portion of the bonded portion 103 protrudes slightly forward from the front end 107B of the wire barrel 107. The value of the protrusion dimension of the bonded portion 103 from the wire barrel 107 (protrusion amount toward the front side) is smaller than the value of the height dimension of the bonded portion 103.

One end 103B (front end) of the bonded portion 103 may be located slightly on the rear side relative to the front end 107B of the wire barrel 107.

The other end 103A (rear end) of the bonded portion 103 is located slightly on the front side relative to the rear end 107A of the wire barrel 107. As a result, the wire barrel 107 encapsulates the front end portion of the conductor 113B in the non-bonded state between the bonded portion 103 and the sheath 111.

The dimension value (the dimension value in the front-rear direction) between the rear end 103A of the bonded portion 103 and the rear end 107A of the wire barrel 107 is also smaller than the value of the height dimension of the bonded portion 103.

In the terminal-equipped electric wire 101, the value of the height dimension of the conductor 113B in the non-bonded state gradually increases from the front side to the rear side. The front end (the rear end of the conductor 113B in the non-bonded state) of the sheath 111 of the electric wire 105 is located slightly on the front side relative to the front end of the insulation barrel portion 117.

Here, a method of manufacturing the terminal-equipped electric wire 101 will be described. The terminal-equipped electric wire 101 is manufactured through a bonded portion forming process and a terminal installing (fixing) process.

In the bonded portion forming process, the conductor 113 is bonded at part of the exposed conductor 113A in the longitudinal direction to form the bonded portion 103.

Subsequently, after forming the bonded portion 103 in the bonded portion forming process, as shown in FIG. 13, the electric wire 105 is positioned with respect to the terminal 109.

Subsequently, in the terminal installing process, the wire barrel 107 and the insulation barrel portion 117 are caulked to install the terminal 109 on the electric wire 105. At this time, the rear end 107A of the wire barrel 107 is located on the rear side relative to the rear end 103A of the bonded portion 103, and the wire barrel 107 wraps and covers at least part of the bonded portion 103.

According to the terminal-equipped electric wire 101, the wire barrel 107 covers the bonded portion 103 so that the rear end 107A of the wire barrel 107 is located on the rear side relative to the rear end 103A of the bonded portion 103. Thus, it is possible to suppress cut of the strand 115 at the boundary portion 103A (boundary between the bonded portion 3 and the conductor 113B in the non-bonded state) of the bonded portion 103.

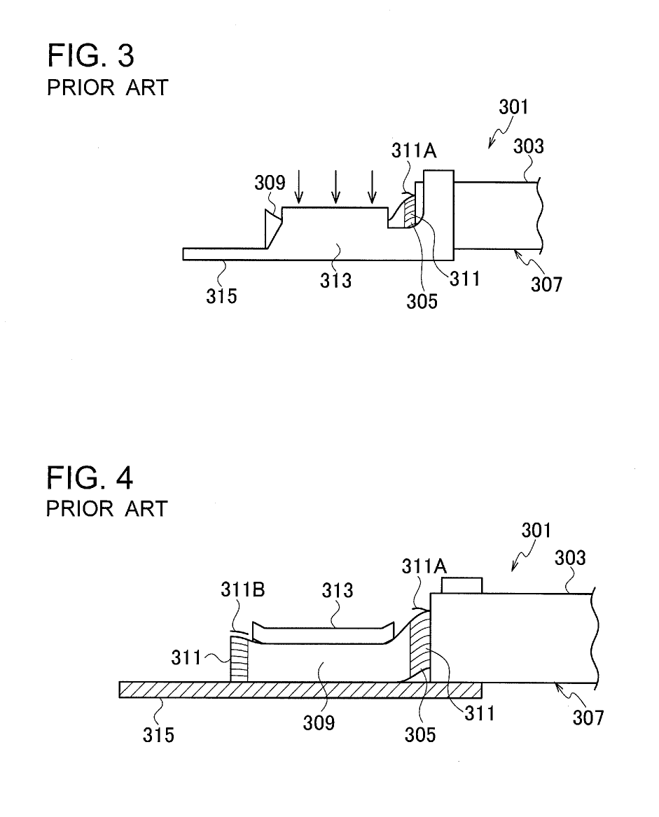

That is, when caulking the wire barrel 107 to the electric wire 105 forming the bonded portion 103 and crimping the terminal 109, the rear end 103A (boundary portion between the bonded portion and the conductor in the non-bonded state) of the bonded portion 103 is located within the wire barrel 107. Thus, the boundary portion 103A is hardly pulled by the crimping of the terminal 109, so that it is possible to suppress cut of the core wire at the boundary portion 103A (cut of the strands 115 even in the non-bonded state conductor 113B; cut of the strands indicated by reference numerals 311A and 311B in FIGS. 3 and 4).

By suppressing cut of the strand 115, the performance of the crimping part is stabilized (the degree of mechanical bonding and the degree of electrical bonding between the electric wire 105 and the terminal 109 are stabilized), and the occurrence of contamination is suppressed.

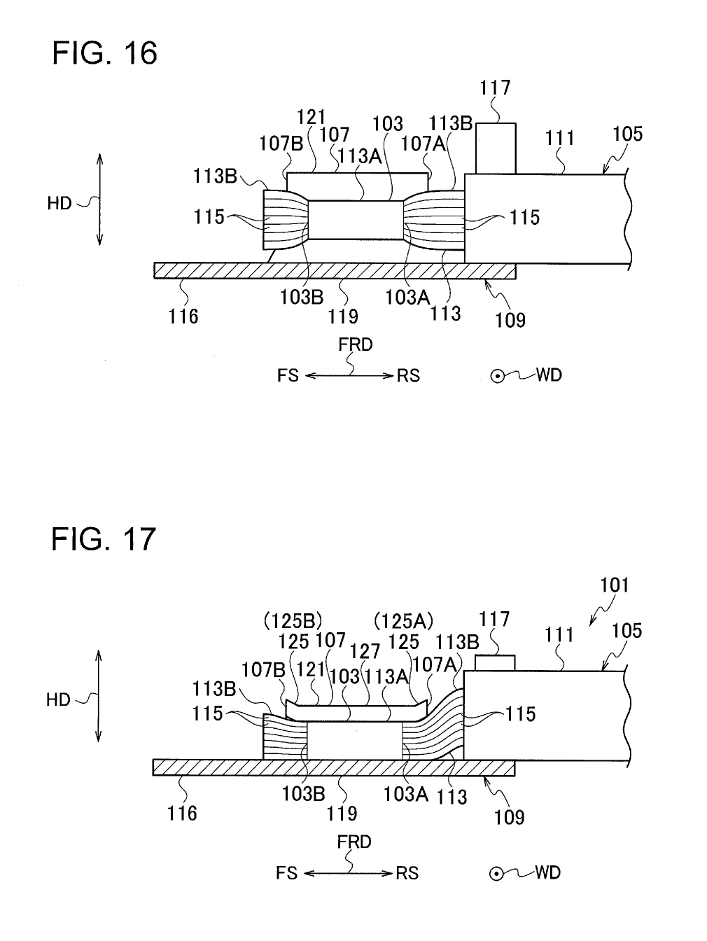

In the above description, as shown in FIG. 15 and the like, the bonded portion 103 protrudes slightly forward from the front end 107B of the wire barrel 107. As shown in FIG. 16, the front end 107B of the wire barrel 107 may be located on the front side relative to a front end 103B of the bonded portion 103. That is, the dimension value of the wire barrel 107 in the front-rear direction is larger than the dimension value of the bonded portion 103 in the front-rear direction. In the front-rear direction, the bonded portion 103 may be located inside the wire barrel 107.

Also, in FIG. 16, the conductor 113B in the non-bonded state protrudes slightly forward from the front end 103B of the bonded portion 103. The conductor 113B in the non-bonded state protruding on the front side relative to the front end 103B of the bonded portion 103 may be eliminated.

According to the terminal-equipped electric wire 101 shown in FIG. 16, the bonded portion 103 is located inside the wire barrel 107 in the front-rear direction. Thus, cut of the strands 115 at both ends (the rear end 103A and the front end 103B) of the bonded portion 103 can be suppressed.

In the terminal-equipped electric wire 101 shown in FIGS. 13 to 16 the wire barrel 107 is not provided with a bell mouth portion. As shown in FIGS. 17 to 19, a bell mouth portion 125 may be provided on the wire barrel 107.

In this case, the bell mouth portion 125 is provided in a mode in which it protrudes rearward from the rear end 107A of the wire barrel 107 of the terminal-equipped electric wire 101 shown in FIGS. 13 to 16, and in a mode in which it protrudes forward from the front end 107B of the wire barrel 107 of the terminal-equipped electric wire 101 shown in FIGS. 13 to 16.

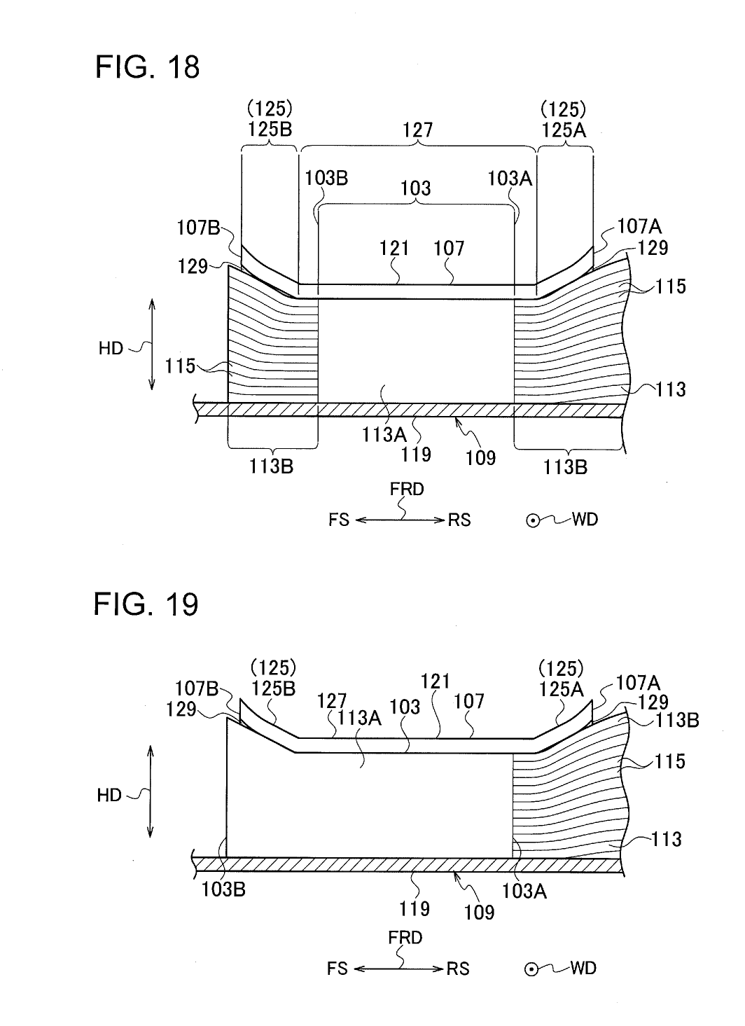

In the terminal-equipped electric wire 101 shown in FIGS. 17 and 18, the wire barrel 107 includes a main body portion 127 and a pair of bell mouth portions 125 (a rear bell mouth portion 125A and a front bell mouth portion 125B). In the front-rear direction, the front bell mouth portion 125B, the main body portion 127, and the rear bell mouth portion 125A are arranged in this order from the front side to the rear side.

More specifically, the bell mouth portion 125 (rear bell mouth portion 125A) is formed at an end portion (rear end portion) of the wire barrel 107 located on the sheath 111 side.

In the terminal-equipped electric wire 101 shown in FIGS. 17 and 18, the front end of the rear bell mouth portion 125A (the end opposite to the rear end located on the sheath 111 side in the front-rear direction; the boundary between the rear bell mouth portion 125A and the main body portion 127) is located on the sheath 111 side (rear side) relative to the rear end 103A (the end located on the sheath 111 side in the longitudinal direction) of the bonded portion 103.

In the terminal-equipped electric wire 101 shown in FIG. 17 and FIG. 18, the main body portion 127 of the wire barrel 107 is formed in a cylindrical shape whose diameter is substantially constant in the front-rear direction, and as the rear bell mouth portion 125A is away from the main body portion 127 (as it goes from the front side to the rear side), it is formed in a cylindrical shape having a gradually increasing diameter. The diameter of the front end of the rear bell mouth portion 125A (the diameter at the boundary with the main body portion 127) is the same as the diameter of the main body portion 127.

In the terminal-equipped electric wire 101 shown in FIGS. 17 and 18, as in the rear bell mouth portion 125A, the front bell mouth portion 125B is formed in a cylindrical shape having a gradually increasing diameter as it is away from the main body portion 127 (from the rear side toward the front side).

In the terminal-equipped electric wire 101 shown in FIGS. 17 and 18, the dimension of the front bell mouth portion 125B in the front-rear direction and the dimension of the rear bell mouth portion 125A in the front-rear direction are smaller than the value of the height dimension of the bonded portion 103, and the dimension of the main body portion 127 in the front-rear direction of the wire barrel 107 is larger than the value of the height dimension of the bonded portion 103.

Further, in the terminal-equipped electric wire 101 shown in FIGS. 17 and 18, in the front-rear direction, the conductor 113 which is present between the main body portion 127 of the wire barrel 107 and the sheath 111 (the rear conductor 113B in the non-bonded state located between the front end of the rear bell mouth portion 125A and the sheath 111) has a height dimension and a diameter value which gradually become larger as they go rearward.

In the terminal-equipped electric wire 101 shown in FIGS. 17 and 18, from the front end of the bonded portion 103 of the electric wire 105, a conductor 113B (a conductor in a non-bonded state on the front side) in a non-bonded state protrudes forward by a predetermined length.

Consequently, with the terminal-equipped electric wire 101 shown in FIGS. 17 and 18, in the front-rear direction, the rear end (the boundary between the front conductor 113B in the non-bonded state and the bonded portion 103) of the front conductor 113B in the non-bonded state is located on the rear side relative to the rear end of the front bell mouth portion 125B, and the front end of the front conductor 113B in the non-bonded state is located on the front side relative to the front end of the front bell mouth portion 125B.

Further, as shown in FIG. 18, at the front end (opening at the front end) of the front bell mouth portion 125B, a slight gap 129 is formed between the conductor 113 (front conductor 113B in the non-bonded state) and the front bell mouth portion 125B, and a slight gap 129 is also formed between the conductor 113 and the rear bell mouth portion 125A at the rear end (opening at the rear end) of the rear bell mouth portion 125A.

At the front end (opening at the front end) of the front bell mouth portion 125B, the front bell mouth portion 125B and the conductor 113 may be in contact with each other, and the front bell mouth portion 125E may suppress the conductor 113. At the rear end (opening at the rear end) of the rear bell mouth portion 125A, the rear bell mouth portion 125A may be in contact with the conductor 113, and the rear bell mouth portion 125A may suppress the conductor 113.

In the terminal-equipped electric wire 101 shown in FIGS. 17 and 18, either the rear bell mouth portion 125A or the front bell mouth portion 125B may be eliminated. For example, the front bell mouth portion 125B may be eliminated. In this case, in the terminal-equipped electric wire 101, in the front-rear direction, the rear end of the front conductor 113B in the non-bonded state is located on the rear side relative to the front end of the main body portion 127 of the wire barrel 107.

According to the terminal-equipped electric wire 101 shown in FIGS. 17 and 18, the bonded portion 103 is located inside the main body portion 127 (the main body portion excluding the bell mouth portion 125) of the wire barrel 107. Thus, cut of the conductor 113 when the terminal 109 is installed in the electric wire 105 can be suppressed.

Further, according to the terminal-equipped electric wire 101 shown in FIG. 17 and FIG. 18, part (a portion on the bonded portion 103 side) of the conductor 113B in the non-bonded state is contained within the bell mouth portion 125. Thus, it is possible to further suppress cut of the conductor 113 at the boundary portion between the bonded portion 103 and the conductor 113B in the non-bonded state.

In the terminal-equipped electric wire 101 shown in FIGS. 17 and 18 in which the bell mouth portion 125 is provided, the bonded portion 103 is located inside the main body portion 127 of the wire barrel 107. However, in the front-rear direction, the front end of the bonded portion 103 may be located in the intermediate portion of the front bell mouth portion 125B, and the rear end of the bonded portion 103 may be located in the intermediate portion of the rear bell mouth portion 125A.

Further, as shown in FIG. 19, a configuration in which the front conductor 113B in the non-bonded state is eliminated may be employed. In the terminal-equipped electric wire 101 shown in FIG. 19, the front end of the bonded portion 103 is located on the front side relative to the front end of the front bell mouth portion 125B. The front end of the bonded portion 103 may be located on the rear side relative to the rear end of the front bell mouth portion 125B, and the front end of the bonded portion 103 may be located at the front bell mouth portion 125B.

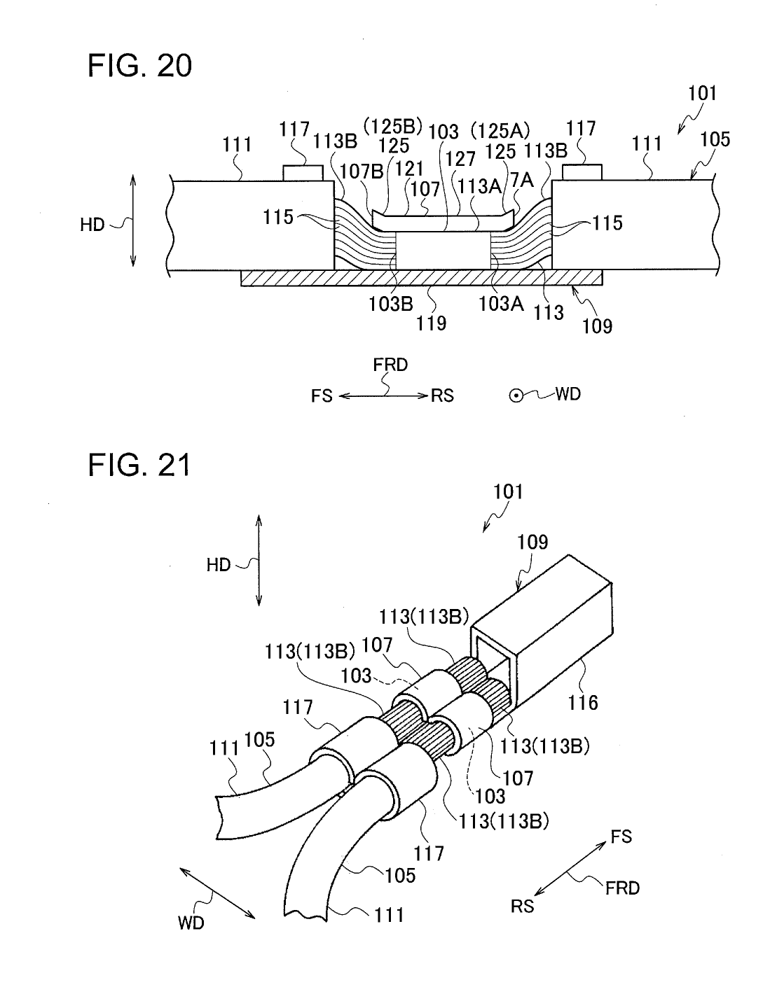

In the above description, the bonded portion 103 is formed at one end portion in the longitudinal direction of the electric wire 105, and the terminal 109 is installed therein. However, as shown in FIG. 20, the bonded portion 103 may be formed at the intermediate portion of the electric wire 105 in the longitudinal direction, and the terminal 109 may be installed therein.

More specifically, the terminal 109 may be installed at the bonded portion 103 of the electric wire in which, from one side of the electric wire 105 in the longitudinal direction to the other side, the conductor 113 (one end side portion of the electric wire in which the sheath is present) covered with the sheath 111, the conductor 113B (conductor in a non-bonded state on one end side) in the non-bonded state, bonded portion 103, a conductor 113E (conductor in the non-bonded state on the other end side) in the non-bonded state, and the conductor 113 covered with the sheath 111 (the other end side portion of the electric wire in which the sheath is present) are arranged in this order.

In such a terminal-equipped electric wire, in the longitudinal direction of the electric wire 105 (the front-rear direction of the terminal 109), the value of the length dimension of the wire barrel 107 (or the main body portion 127 of the wire barrel) of the terminal 109 is larger than the value of the length dimension of the bonded portion 103, and, in the longitudinal direction of the electric wire 105 (the front-rear direction of the terminal 109), the bonded portion 103 is located inside the wire barrel 107 (or the main body portion 127 of the wire barrel) of the terminal 109.

Furthermore, in the above description, one terminal 109 is provided on one electric wire 105. As shown in FIG. 21, one terminal 109 may be provided for a plurality of (for example, two) electric wires 105. That is, as in the case described above, the wire barrel 107 may be installed at the bonded portion 103 of each electric wire 105 so that the bonded portion 103 of each electric wire 105 is placed inside the wire barrel 107 (or the main body portion 127 of the wire barrel) of one terminal 109.

Further, when one terminal 109 is installed for a plurality of electric wires 105, the bonded portion 103 may be individually formed on the conductor 113 of each electric wire 105 and one terminal 109 may be provided for each electric wire 105. The conductors 113 of at least two the electric wires 105 among the electric wires 105 may be collected, the bonded portion 103 may be formed on the collected conductors, and one terminal 109 may be provided for each electric wire 105.

Further, when one terminal 109 is installed for a plurality of electric wires 105, with at least one electric wire 105 among the electric wires 105, the bonded portion 103 may be formed at an intermediate portion of the electric wire 105 in the longitudinal direction.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

What is claimed is:

1. An ultrasonic bonding method of a conductor of an electric wire, the method comprising:
ultrasonically bonding strands forming a conductor of at least one electric wire using anvils and a horn,
wherein the anvils are arranged in a longitudinal direction of the strands.

2. The ultrasonic bonding method of a conductor of an electric wire according to claim 1, wherein
the conductor is exposed over a predetermined length due to absence of a sheath at one end portion of the electric wire in a longitudinal direction of the electric wire, and
when ultrasonically bonding the conductor, a predetermined number of anvils of the anvils is used in order from an anvil located close to the sheath depending on a length of the exposure of the conductor in the longitudinal direction.

3. The ultrasonic bonding method of a conductor of an electric wire according to claim 2, wherein a dimension value of a first anvil of the anvils in a longitudinal direction of the strands is larger than a dimension value of a second anvil of the anvils in the longitudinal direction of the strands, the second anvil being adjacent to the first anvil in the longitudinal direction of the strands and positioned closer to the one end portion of the electric wire than the first anvil.

4. The ultrasonic bonding method of a conductor of an electric wire according to claim 1, wherein
when performing the ultrasonic bonding, the strands are sandwiched by respective planar portions of the anvils, and
pressing forces per unit area of the respective planar portions of the anvils are equal to each other.

5. An ultrasonic bonding method of a conductor of an electric wire, the method comprising:
ultrasonically bonding strands forming a conductor of an electric wire using an anvil and a horn, wherein
one end portion of the conductor in a longitudinal direction of the conductor protrudes from one end of a sandwiched portion formed by the anvil and the horn, or a position of one end of the conductor in the longitudinal direction and a position of the one end of the sandwiched portion match with each other in the longitudinal direction, and
the other end portion of the conductor in the longitudinal direction protrudes from the other end of the sandwiched portion in the longitudinal direction.

6. A method of manufacturing a terminal-equipped electric wire, the method comprising:
by using the ultrasonic bonding method of a conductor of an electric wire according to claim 1, forming a bonded portion by bonding the conductor at a part of an exposed portion of the conductor in a longitudinal direction of the electric wire, the exposed portion at which the conductor is exposed due to absence of a sheath over a predetermined length at a part of the electric wire in the longitudinal direction; and
after forming the bonded portion, installing a terminal with a wire barrel on an electric wire such that the wire barrel covers at least a part of the bonded portion with an end of the wire barrel on a sheath side of the electric wire being located closer to the sheath than an end of the bonded portion on the sheath side.

7. The method of manufacturing a terminal-equipped electric wire according to claim 6, wherein
the at least one electric wire comprises electric wires,
the terminal is a single terminal, and
the single terminal is installed on the electric wires.

8. An ultrasonic bonding apparatus for a conductor of an electric wire, the apparatus comprising:
anvils; and
a horn, wherein
the ultrasonic bonding apparatus is configured to ultrasonically bond strands forming the conductor of the electric wire using the anvils and the horn, and
the anvils are arranged in a longitudinal direction of the strands.

9. An electric wire comprising:
strands forming a conductor; and
a bonded portion formed at least in a part of the strands in a longitudinal direction of the strands, wherein
a part of a surface of the bonded portion includes a first pressed portion and a second pressed portion, and
the first pressed portion and the second pressed portion are arranged in a row in a longitudinal direction of the bonded portion.
